(19) United States
(12) Patent Application Publication
(10) Pub. No.: US 2024/0020355 A1
(43) Pub. Date: Jan. 18, 2024

(54) NON-FUNGIBLE TOKEN AUTHENTICATION

(71) Applicant: TOKENFORM LLC, Denver, CO (US)

(72) Inventors: Jeffrey Binder, Denver, CO (US); Charles Hasek, Denver, CO (US); Lindsay Gardner, West Hollywood, CA (US)

(21) Appl. No.: 18/221,620

(22) Filed: Jul. 13, 2023

Related U.S. Application Data
(60) Provisional application No. 63/389,633, filed on Jul. 15, 2022.

(51) Int. Cl. G06F 21/10; H04L 9/00

(52) U.S. Cl. CPC G06F 21/10; H04L 9/50; H04L 2209/603

(57) ABSTRACT

A system uses one or more non-fungible tokens (NFTs) for authentication. An NFT and an associated smart contract may be generated and stored on a blockchain for authority that is to be delegated to a delegate on behalf of a delegator. The NFT may then be provided to the delegate, who may use the NFT to authenticate himself in order to act on the delegated authority. Subsequently, the NFT may be transferred, revoked, marked expired, and/or otherwise controlled by the delegator in order to control the authority delegated to the delegate.

### CROSS-REFERENCE TO RELATED APPLICATION

This application is a nonprovisional patent application of and claims the benefit under 35 U.S.C. § 119(e) of U.S. Provisional Patent Application No. 63/389,633, filed Jul. 15, 2022, and titled “Non-Fungible Token Authentication,” the contents of which are incorporated herein by reference in its entirety.

### FIELD

The described embodiments relate generally to authentication. More particularly, the present embodiments relate to using non-fungible tokens for authentication.

### BACKGROUND

A blockchain is a distributed ledger that is shared among nodes of a decentralized computer network. Blockchains are similar to databases in that they store information electronically in digital format. However, unlike a database, blockchains collect information together in groups, known as blocks. As blocks are filled they are closed, timestamped, and linked to a previously filled block. This data structure inherently makes an irreversible timeline of data when implemented in a decentralized nature.

One use of blockchains is to store non-fungible tokens (NFTs). NFTs are cryptographic assets on a blockchain with unique identification codes and metadata that distinguish them from each other. NFTs are typically used to represent rights to real world assets, such as artworks. NFTs are associated with a smart contract stored on the blockchain that controls transactions that can be performed with the NFTs and who can perform them. NFTs are accessible using private and/or public keys stored in a local and/or cloud-based token wallet assigned to the owner of the respective NFT, and ownership is tracked on the blockchain.

### OVERVIEW

The present disclosure relates to use of non-fungible tokens (NFTs) for authentication. An NFT and an associated smart contract may be generated and stored on a blockchain for authority that is to be delegated to a delegate on behalf of a delegator. The NFT may then be provided to the delegate, who may use the NFT to authenticate himself in order to act on the delegated authority. Subsequently, the NFT may be transferred, revoked, marked expired, and/or otherwise controlled by the delegator in order to control the authority delegated to the delegate.

In various embodiments, a system includes a non-transitory storage medium storing instructions and a processor. The processor executes the instructions to receive a request to delegate authority to a delegate on behalf of a delegator, generate a non-fungible token (NFT) and an associated smart contract, store the NFT and the associated smart contract on a blockchain, and provide the NFT wherein the NFT is usable by the delegate to make use of the authority.

In some examples, the processor is operable to revoke the NFT in response to a request from the delegator. In a number of examples, the processor is operable to generate a new NFT in response to a request from the delegator. In some implementations of such examples, the processor provides the new NFT to at least one of the delegator or the delegate.

In various examples, the processor is operable to generate a child NFT in response to a request from the delegate. In some examples, the processor provides the NFT to at least one of the delegator or the delegate. In a number of examples, the NFT expires after passage of an expiration date.

In some embodiments, a system includes a non-transitory storage medium storing instructions and a processor. The processor executes the instructions to provide a request to delegate authority to a delegate on behalf of a delegator to cause a host platform to generate a non-fungible token (NFT) and an associated smart contract and store the NFT and the associated smart contract on a blockchain and facilitate providing the NFT to the delegate wherein the NFT is usable by the delegate to make use of the authority.

In various examples, the delegator is a streaming service, a gaming service, an airline site, a bank, or any other password protected site or application. In a number of implementations of such examples, the access is from a device, a website or the like, associated with a token wallet to which the NFT is assigned. In some implementations of such examples, the authority is access to content from the streaming service or the gaming service. A token may also be transferred with an expiration time, date and a set of rights delegated to a third party wallet attached to an app or website owned by the recipient which allows the recipient to log into to the target app or website and assume the identity of the first party without the first party having to share its user identifier or password.

In some examples, the NFT is a child token generated on behalf of the delegator who has a parent token. In a number of examples, the processor renders the NFT unusable, generates a new NFT, and provides the new NFT. In some implementations of such examples, the processor provides the new NFT to at least one of the delegator or the delegate.

In a number of embodiments, a system includes a non-transitory storage medium storing instructions and a processor. The processor executes the instructions to receive a non-fungible token (NFT) that was generated and stored on a blockchain with an associated smart contract by a host platform in response to a request to delegate authority to a delegate on behalf of a delegator and make use of the authority using the NFT in response to a request from the delegate.

In various examples, the processor is operable to obtain a code from an electronic device, determine that the NFT is assigned to a token wallet associated with the processor, and submit an authorization request for the electronic device. In some implementations of such examples, the authorization request requests configuration of the electronic device with at least one of a streaming service, a gaming service, an airline site, a bank, or any other password protected site or application.

In some examples, the processor is operable to store the NFT in a token wallet associated with the processor. In various implementations of such examples, the token wallet is integrated with at least one of a streaming service app, a gaming service app, an airline app, a bank app, or a financial institution app.

In a number of examples, the processor is operable to transfer the NFT.

### BRIEF DESCRIPTION OF THE DRAWINGS

The disclosure will be readily understood by the following detailed description in conjunction with the accompanying drawings, wherein like reference numerals designate like structural elements.

FIG. 1A depicts an example non-fungible token authentication system.

FIG. 1B depicts a flow of using creation and minting of a smart contract and non-fungible token. The flow may be performed by the system of FIG. 1A.

FIG. 1C depicts a list of backend services. The backend services may support and/or be provided by the system of FIG. 1A.

FIG. 1D depicts mint-print-manage functions. The mint-print-manage functions may be performed and/or supported and/or provided by the system of FIG. 1A.

FIG. 2 depicts a flow chart illustrating a first example method for operating a non-fungible token authentication system. This method may be performed by the system of FIG. 1A.

FIG. 3 depicts example relationships among example components that may be used to implement the system of FIG. 1A.

FIG. 4 depicts a flow chart illustrating a second example method for operating a non-fungible token authentication system. This method may be performed by the system of FIG. 1A.

FIG. 5 depicts a flow chart illustrating a third example method for operating a non-fungible token authentication system. This method may be performed by the system of FIG. 1A.

FIG. 6 depicts a flow chart illustrating a fourth example method for operating a non-fungible token authentication system. This method may be performed by the system of FIG. 1A.

FIG. 7 depicts a flow chart illustrating a fifth example method for operating a non-fungible token authentication system. This method may be performed by the system of FIG. 1A.

FIG. 8 depicts a flow chart illustrating a sixth example method for operating a non-fungible token authentication system. This method may be performed by the system of FIG. 1A.

FIG. 9 depicts a flow chart illustrating a seventh example method for operating a non-fungible token authentication system. This method may be performed by the system of FIG. 1A.

FIG. 10 depicts a flow chart illustrating an eighth example method for operating a non-fungible token authentication system. This method may be performed by the system of FIG. 1A.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The description that follows includes sample systems, methods, apparatuses, and computer program products that embody various elements of the present disclosure. However, it should be understood that the described disclosure may be practiced in a variety of forms in addition to those described herein.

Authentication is a consistent problem that administrators of resources must contend with. Credentials for such authentication are often shared, lost, stolen, and so on, often resulting in improper access to and/or compromise of resources. This is particularly the case in digital environments that exacerbate this problem due to what is in other scenarios the technological advantage of enhanced and distributed access to resources, credentials, and so on.

For example, passwords and/or similar mechanisms (such as personal identification numbers, access codes, and so on) are often used to guard access to resources. However, passwords may be improperly shared, as well as lost, stolen, forgotten and so on. As such, administrators of resources that use passwords and/or similar mechanisms to guard resources may be unable to control exactly who and/or how many people have access to the resources.

Multi-factor authentication may provide some advantages over passwords alone. For example, confirmation codes may be sent to registered communication identifiers, such as email addresses, text message numbers, and so on. However, many of these registered communication identifiers may be compromised as well. Even if such registered communication identifiers are not compromised, configuring the use of such registered communication identifiers may be burdensome for administrators of resources, and some users may not even have registered communication identifiers usable for such a purpose.

Further, administrators of resources and/or other entities often maintain large, expensive, and complex databases of information related to authentication mechanisms. Without such databases, the administrators of resources and/or other entities themselves may be unable to perform authentication. This increases cost, complexity, and burden on the administrators of resources and/or other entities, and results in such databases being weak points for failure and/or attack. Should such databases fail, the administrators of resources and/or other entities may be unable to perform authentication. Should such databases be compromised, the administrators of resources and/or other entities may be unable to prevent unauthorized access to the resources, and could potentially face liability if appropriate care was not taken to safeguard the information stored on behalf of others.

The present disclosure relates to use of non-fungible tokens (NFTs) for authentication. An NFT and an associated smart contract may be generated and stored on a blockchain for authority that is to be delegated to a delegate on behalf of a delegator. The NFT may then be provided to the delegate, who may use the NFT to authenticate himself in order to act on the delegated authority. Subsequently, the NFT may be transferred, revoked, marked expired, and/or otherwise controlled by the delegator in order to control the authority delegated to the delegate.

In this way, the present disclosure may provide technological solutions to authentication issues, particularly technological solutions that arise from the technological problems introduced by attempting to perform authentication in a digital environment. A system and/or device using the techniques of the present disclosure may be able to perform authentication and/or other functions that the system and/or device would not previously have been able to perform absent the technology disclosed herein. This may enable the system and/or device to operate more efficiently while consuming fewer hardware and/or software resources as more resource consuming techniques may be omitted. Further, one or more databases and/or other components may be omitted while still enabling authentication and/or other functions, reducing unnecessary hardware and/or software components and providing greater system flexibility and security.

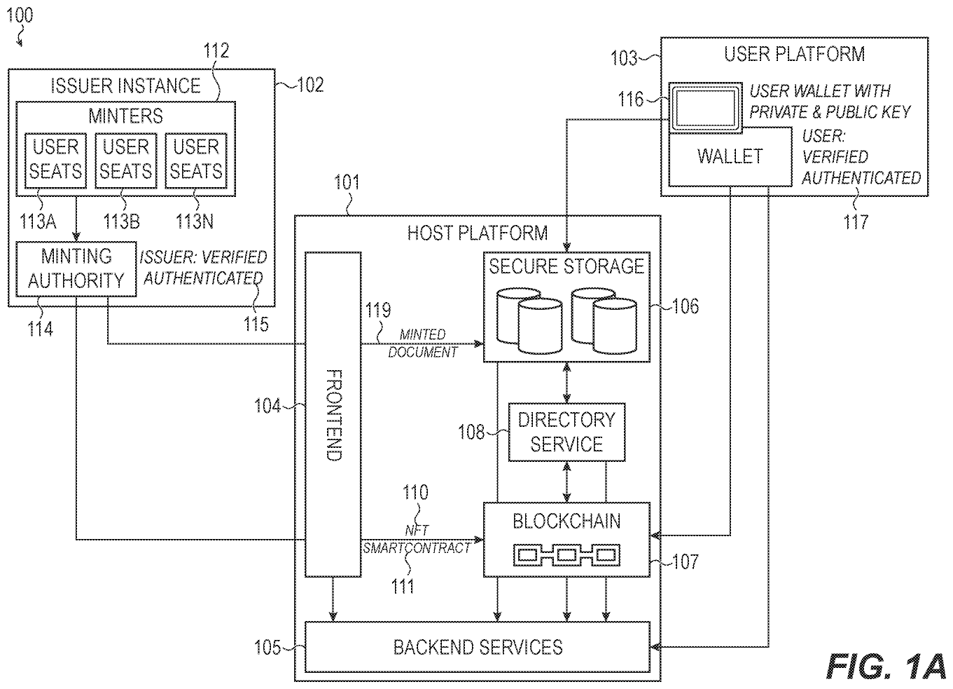

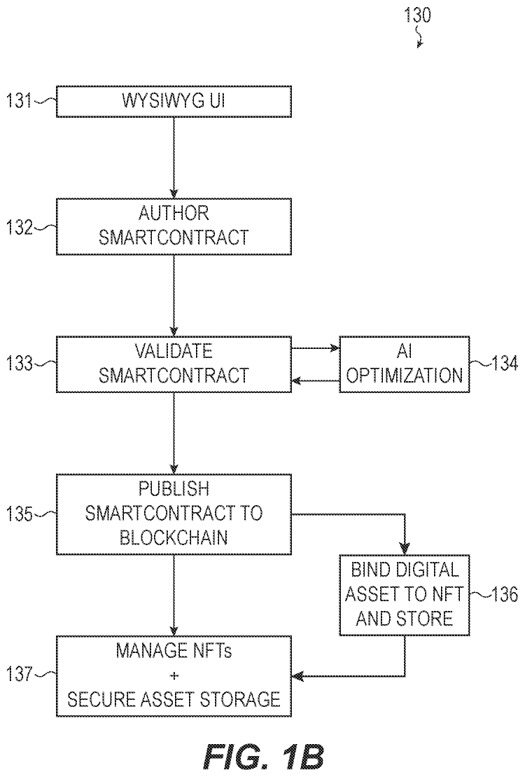

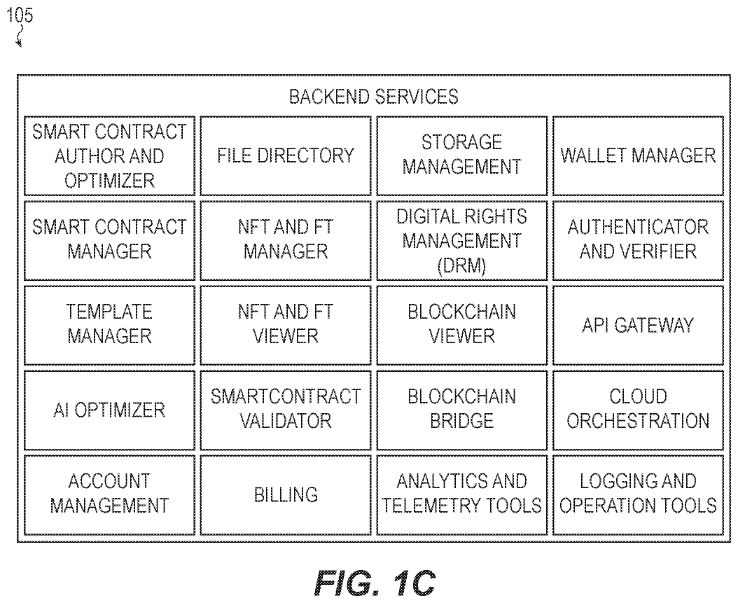

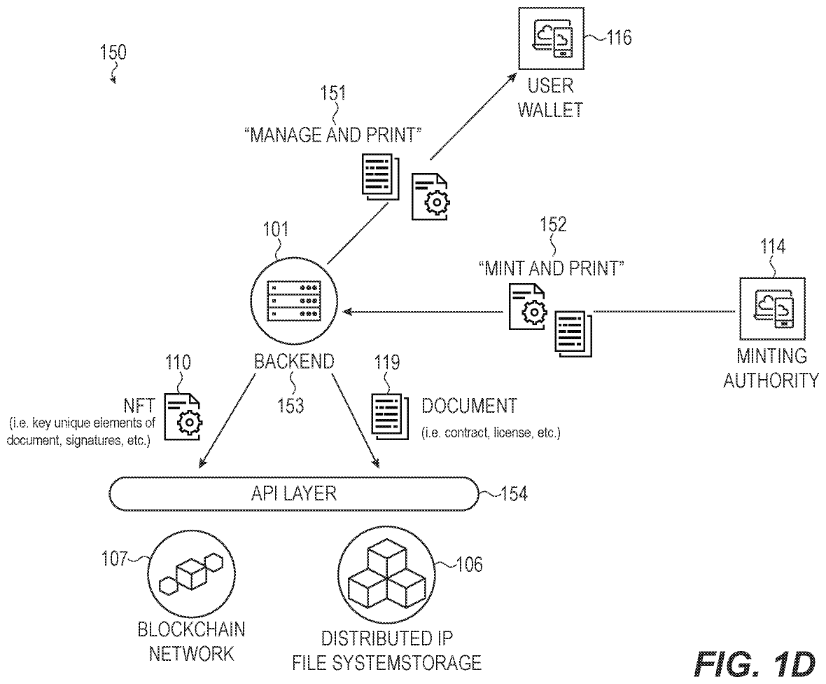

These and other embodiments are discussed below with reference to FIGS. 1A-10. However, those skilled in the art will readily appreciate that the detailed description given herein with respect to these Figures is for explanatory purposes only and should not be construed as limiting.

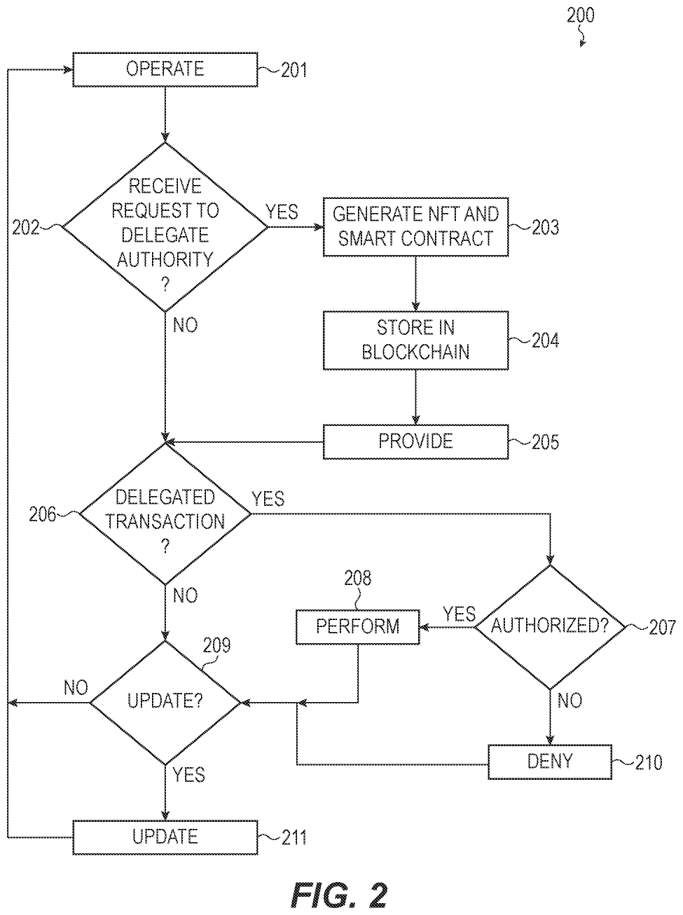

FIG. 1A depicts an example NFT authentication system 100. The system 100 may use NFTs for authentication. The system 100 may generate an NFT 110 and an associated smart contract 111 and store them on a blockchain for authority that is to be delegated to a delegate on behalf of a delegator. The system 100 may provide the NFT directly and/or indirectly to the delegate, who may use the NFT to authenticate himself in order to act on the delegated authority. Subsequently, the system 100 may allow the NFT to be transferred, revoked, marked expired, and/or otherwise controlled directly and/or indirectly by the delegator in order to control the authority delegated to the delegate. The actions that may be performed with the NFT may be controlled by the smart contract. Examples of such operations are discussed in detail below with respect to FIGS. 2 and 4-10.

The system 100 may include a host platform 101 that is operable to create and/or perform one or more transactions and/or other actions related to one or more NFTs 110, smart contracts 111, and/or minted documents 119 on behalf of and/or for one or more other entities, such as one or more issuer instances 102, user platforms 103, intermediaries (not shown), and so on. Creation of the NFTs 110 may involve creation of one or more smart contracts 111, storage of the smart contracts 111 and/or the NFTs 110 in one or more blockchains, automatic creation and/or maintenance of one or more local and/or cloud-based token wallets (an electronic repository associated with storage of at least one or more private keys associated with one or more NFTs 110 and/or other tokens associated with one or more blockchains), and so on. In some cases, the private keys for the NFTs 110 and/or other encrypted and/or unencrypted data (such as one or more public keys, copies of the NFTs 110, payloads, and so on) may be stored in one or more local and/or cloud-based token wallets. The NFT document platform may also be operable to mint one or more documents, such as one or more birth certificates, contracts and other signed documents, titles (such as house titles, car titles, and so on), prescriptions, licenses and/or identification documents, checks, money, gift cards, and so on. The smart contracts 111 and/or NFTs 110 may correspond to the one or more minted documents 119 and may even be created using data from and/or otherwise associated with the minted documents 119. The NFTs may be usable to authenticate the minted documents 119, evidence ownership of the minted documents 119, control the ability to perform transactions regarding the minted documents 119, and so on.

For example, an online tax preparation service may be a first issuer instance 102 and a streaming television and movie service may be a second issuer instance. The online tax preparation service may allow a customer using the user platform 103 to create one or more NFTs and/or associated smart contracts via the host platform 101 to delegate authority to a tax preparation professional to access stored tax information for the customer in order to review the customer's tax forms. The tax professional may not have a token wallet associated with the online tax preparation service. However, the host platform 101 may have automatically created a token wallet associated with the tax professional's email address for the tax professional's streaming television and movie service account in order to store NFTs that the tax professional uses to access streaming television and movie content from the streaming television and movie service. When the customer delegates authority to the tax professional, the customer may provide the tax professional's email address. The host platform 101 may recognize that a token wallet is already associated with that email address and may associate the NFT that is accordingly created with that token wallet. However, token wallets may include hidden areas. When the tax professional accesses the token wallet for the streaming television and movie service, the tax professional may not see the NFT for the online tax preparation service. However, when the online tax preparation service associates the NFT with the token wallet, the tax professional may be sent an email notifying the tax professional that the customer has delegated the authority. The email may include a link to access the customer's tax forms, which may both send a one-time password to the tax professional's email account and prompt the tax professional to enter the sent one-time password. When the tax professional provides the sent one-time password, the online tax preparation service may allow the tax professional to access the customer's tax forms. Various configurations are possible and contemplated without departing from the scope of the present disclosure.

Although the above example is described in the context of an online tax preparation service and a streaming television and movie service, it is understood that this is an example. In various implementations, the techniques of the present disclosure may be used with anything that uses credentials. Various configurations are possible and contemplated without departing from the scope of the present disclosure.

The host platform 101 may include one or more frontends 104 and/or one or more backend services 105. The frontend 104 may include one or more application programming interfaces or “APIs”. Similarly, the backend services 105 may be accessed using one or more APIs. The frontend 104 may be usable by one or more issuer instances 102 to request creation of and/or performance of one or more transactions and/or other actions related to one or more NFTs 110, smart contracts 111, and/or minted documents 119. The frontend 104 may interact with one or more unsecure and/or secure storages 106 and/or one or more blockchains 107 to store one or more NFTs 110, smart contracts 111, minted documents 119, and so on. A directory service 108 may by usable by the host platform 101 to associate assets in the one more unsecure and/or secure storages 106 and/or one or more blockchains 107. The frontend 104 and/or the one or more blockchains 107 may be communicably connected to the backend services 105.

The issuer instance 102 may include one or more minters 112 that may include one or more user seats 113A-113N, a minting authority 114, an issuer 115, and so on. The issuer 115 may be verified and authenticated by the host platform 101, such as by communication over a verified connection, using multi-factor authentication (such as a login and/or password, a one-time password sent to a known email address and/or other communication address, one or more authenticator apps, and so on), and so on. The minting authority 114 and/or the issuer instance 102 may be communicably connected to the frontend 104.

The user platform 103 may include a user wallet 116 and a user 117. The user wallet 116 may be a token wallet. The user wallet 116 may store one or more private and/or public keys related to one or more NFTs. The user wallet 116 and/or the user platform 103 may be communicably connected to the one more unsecure and/or secure storages 106, one or more blockchains 107, and/or backend services 105. The user 117 may be verified and authenticated by the host platform 101, such as by communication over a verified connection, using multi-factor authentication (such as a login and/or password, a one-time password sent to a known email address and/or other communication address, one or more authenticator apps, and so on), and so on.

FIG. 1B depicts a flow 130 of using creation and minting of a smart contract and non-fungible token. The flow may be performed by the system 100 of FIG. 1A. A what you see is what you get (“WYSIWYG”) and/or other user interface 131 may be provided. The user interface 131 may be used to author one or more smart contracts 132. The authored smart contracts may be validated 133 and/or optimized using artificial intelligence (AI) 134. The validated and/or optimized smart contract (and/or any generated related one or more NFTs) may be published to one or more blockchains 135. A digital asset related to the smart contract may be bound to the one or more NFTs and stored 136. The one or more NFTs may then be managed and the digital asset may be securely and/or otherwise stored 137.

Although the flow 130 illustrates a particular flow, it is understood that this is an example. In other implementations, other flows of the same, similar, and/or different operations may be used. Various configurations are possible and contemplated without departing from the scope of the present disclosure.

FIG. 1C depicts a list of backend services 105. The backend services 105 may support and/or be provided by the system 100 of FIG. 1A. The list may include one or more smart contract authors and/or optimizers, file directories, storage management, wallet managers, smart contract managers, NFT and FT managers, digital rights management (DRM), authenticators and/or verifiers, template managers, NFT and/or FT viewers, blockchain viewers, API gateways, AI optimizers, smart contract validators, blockchain bridges, cloud orchestration, account management, billing, analytics and/or telemetry tools, logging and operation tools, and so on.

Although the list illustrates examples of backend services 105, it is understood that this is an example. In other implementations, other backend services 105 may be used. Various configurations are possible and contemplated without departing from the scope of the present disclosure.

FIG. 1D depicts mint-print-manage functions 150. The mint-print-manage functions 150 may be performed and/or supported and/or provided by the system of FIG. 1A. As shown, a host platform may communicate with a user wallet 116 and/or a minting authority 114 to perform manage and print functions 151 and/or mint and print functions 152. The host platform 101 may use a backend 153 and/or an API layer 154 to store one or more NFTs 110 (which may include key unique elements of one or more documents 119, signature, and so on) in one or more blockchain 107 networks and/or one or more documents 119 (such as one or more contracts, licenses, and so on) in a distributed internet protocol file system storage and/or other unsecure and/or secure storage 106.

Although the mint-print-manage functions 150 are illustrated and described with a particular configuration, it is understood that this is an example. In other implementations, other configurations of the same, similar, and/or different operations may be used. Various configurations are possible and contemplated without departing from the scope of the present disclosure.

Returning to FIG. 1A, although the system 100 is illustrated and described as including particular components arranged in a particular configuration, it is understood that this is an example. In a number of implementations, various configurations of various components may be used without departing from the scope of the present disclosure.

For example, the system 100 is illustrated and described as the user platform 103 including the user wallet 116. However, it is understood that this is an example. In various implementations, the system 100 may include host platform 101 that automatically generates and/or maintains one or more local and/or cloud-based token wallets, such as token wallets associated with one or more communication addresses (such as one or more email addresses, telephone numbers, social media messaging addresses, and so on) of one or more users. This may increase the likelihood that users will use the system 100 as the users do not have to know how to create token wallets, as well as simplifying user interfaces and improving the operation of computing devices used to implement the system 100. Various configurations are possible and contemplated without departing from the scope of the present disclosure.

FIG. 2 depicts a flow chart illustrating a first example method 200 for operating an NFT authentication system. This method may be performed by the system 100 of FIG. 1A.

At operation 201, an electronic device (such as one or more computing devices associated with the host platform 101 of FIG. 1A, the issuer instance 102 of FIG. 1A, the user platform 103 of FIG. 1A, and/or another device or system) may operate. The flow may proceed to operation 202 where the electronic device may determine whether or not a request to delegate authority is received. If so, the flow may proceed to operation 203. Otherwise, the flow may proceed to operation 206.

At operation 203, after the electronic device determines a request to delegate authority is received, the electronic device may generate one or more NFTs and one or more associated smart contracts. Such an NFT may include and/or link to login details and/or other authorization information and/or permissions that enable one or more actions relating to the delegated authority.

The flow may proceed to operation 204 where the electronic device may store the NFT and/or the smart contract in one or more blockchains. The flow may then proceed to operation 205 where the electronic device may provide the NFT. For example, the electronic device may send the NFT to a local and/or cloud-based token wallet associated with the delegate. By way of another example, the electronic device may send the NFT to a local and/or cloud-based token wallet associated with the delegator, the requestor, and so on who may then transfer the NFT to a local and/or cloud-based token wallet associated with the delegate. The flow may then proceed to operation 206.

At operation 206, the electronic device determines whether or not one or more requests to perform one or more delegated transactions are received. A delegated transaction may be any action or task that requires use of the delegated authority. If so, the flow may proceed to operation 207. Otherwise, the flow may proceed to operation 209.

At operation 207, after the electronic device determines that one or more requests to perform one or more delegated transactions are received, the electronic device may determine whether or not the one or more requests to perform the one or more delegated transactions are authorized. The electronic device may determine that the one or more requests to perform the one or more delegated transactions are authorized if an NFT corresponding to delegated authority for performing the one or more delegated transactions is assigned to a token wallet associated with the requestor and/or a device from which the request is received. If so, the flow may proceed to operation 208 where the electronic device performs the one or more delegated transactions before the flow proceeds to operation 209. Otherwise, the flow may proceed to operation 210 where the electronic device may deny the one or more requests to perform one or more delegated transactions before the flow proceeds to operation 209.

At operation 209, the electronic device may determine whether or not to update one or more NFTs. If so, the flow may proceed to operation 211 where the electronic device may update the one or more NFTs before the flow returns to operation 201 where the electronic device continues to operate. Otherwise, the flow may directly return to operation 201 where the electronic device continues to operate.

Such updating may include revoking one or more NFTs, replacing one or more NFTs, modifying one or more NFTs, and so on. Such updating may be performed at the request of the delegator, at the request of the delegate if the NFT provides such authority, and/or at the request of any other party that has authority under the smart contract to modify the NFT. Replacing one or more NFTs may revoke and/or otherwise mark the original NFT as unusable and may generate one or more new NFTs. Such new NFTs may be placed in one or more token wallets assigned to the person or entity who previously held the old NFT, in one or more token wallets assigned to the delegator who may then transfer, and so on.

By way of example of the method 200, an attorney may delegate authority to an assistant that allows the assistant to read emails in the attorney's email inbox and file the emails into one or more sub folders. However, the delegated authority may not enable the assistant to see emails in a FIRM BUSINESS sub folder or any files to which the attorney has access. This delegated authority may be more secure than the attorney simply providing the assistant the attorney's password, or simply logging onto the attorney's account and then stepping aside to allow the assistant to perform email related tasks. The attorney may submit a request to delegate the authority and the electronic device may generate an associated NFT and provide such, directly and/or indirectly, to the assistant.

The NFT in this scenario may be portable by the assistant in that the assistant may be able to take the NFT from device to device in order to be able to conveniently and securely perform one or more tasks associated with the delegated authority. However, it is understood that this is an example. In various examples, the attorney may specify any number of restrictions on the NFT and/or the assistant, such as an expiration date when the NFT will expire, limitations on and/or prevention of the ability to transfer the NFT, time and/or place limitations on the use of the NFT, restrictions on the authority delegated, and so on.

Alternatively, the NFT may not be directly accessible by the assistant. For example, in some implementations, a token wallet may be automatically generated (such as by a host platform) for the assistant when the NFT is assigned to the assistant. The token wallet may be automatically generated and associated with a communication address associated with the assistant, such as an email address, phone number, social media messaging address, and so on. By way of illustration, the attorney may provide the assistant's email address when assigning the NFT and a token wallet associated with that email address may be generated and a notification email may be sent to the assistant at that email address. The email address may include a link to the NFT. Alternatively, the NFT may be hidden from the assistant and the link may be usable by the assistant to utilize the delegated authority. Various configurations are possible and contemplated without departing from the scope of the present disclosure.

By way of another example, a streaming service and/or gaming service (or an airline site, a bank, or another password protected site or application) may delegate authority to use the streaming service and/or gaming service to a customer when the customer signs up for an account. The streaming service and/or gaming service may submit a request to delegate the authority and the electronic device may generate an associated NFT and provide such, directly and/or indirectly, to the customer.

The NFT may enable the customer to access content from the streaming service or the gaming service. The NFT may include information linking the NFT to the customer's account and/or the streaming service or gaming service may maintain information in a database or other data store indicating which accounts correspond to which NFTs.

The customer may be able to use the NFT to configure one or more electronic devices (or a website or the like, associated with a token wallet to which the NFT is assigned) to be used with the streaming service or gaming service. The customer may do this by using another electronic device to obtain a code from an electronic device, determining that the NFT is assigned to a token wallet associated with the other electronic device, and submit an authorization request for the electronic device. By way of illustration, a smart phone may be used to scan a quick response or “QR” code displayed on the television by a streaming service or gaming service. The smart phone may then extract information from the QR code, determine that an NFT granting authority to configure the television to be used with the streaming service or gaming service is assigned to a token wallet associated with the smart phone, and submit an authorization request for the television to be configured to be used with the streaming service or the gaming service.

The customer may also be able to use the NFT to generate one or more child NFTs to which the NFT would be a parent NFT. By way of illustration, the streaming service or the gaming service may configure the NFT to allow the customer to generate up to five child NFTs. The customer may be able to generate child NFTs that can only access a subset of the streaming service or gaming service content that the parent NFT can access, such as only content with a PG-13 rating or lower. The child NFTs may have an expiration date and/or may otherwise be revoked or replaced, whether in response to a request from the customer, from the streaming service or the gaming service, and so on. When a child NFT expires and/or is otherwise revoked, a new NFT may be sent to a token wallet account associated with the customer, who may then transfer the new NFT to the same person and/or a different person from the expired and/or revoked child NFT. When a child NFT is replaced, the new NFT may be sent to a token wallet account associated with the previous holder of the child NFT or the customer, who may then transfer the new NFT to the same person and/or a different person from the replaced child NFT.

In a number of examples, a token may also be transferred with an expiration time, date and a set of rights delegated to a third party wallet attached to an app or website owned by the recipient which allows the recipient to log into to the target app or website and assume the identity of the first party without the first party having to share its user ID or password.

In various examples, this example method 200 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 200 is illustrated and described as including particular operations performed in a particular order, it is understood that this is an example. In various implementations, various orders of the same, similar, and/or different operations may be performed without departing from the scope of the present disclosure.

For example, the above illustrates and describes the electronic device as both receiving requests to delegate authority and requests to perform delegated transactions. However, it is understood that this is an example. In various implementations, different devices may receive requests to delegate authority and requests to perform delegated transactions. Various configurations are possible and contemplated without departing from the scope of the present disclosure.

By way of another example, the above illustrates and describes generating the NFT and the smart contract. However, it is understood that this is an example. In some implementations, the electronic device may generate the NFT and/or the smart contract by requesting generation of such, such as via one or more APIs of a device such as a computing device associated with the host platform 101 of FIG. 1A. Various configurations are possible and contemplated without departing from the scope of the present disclosure.

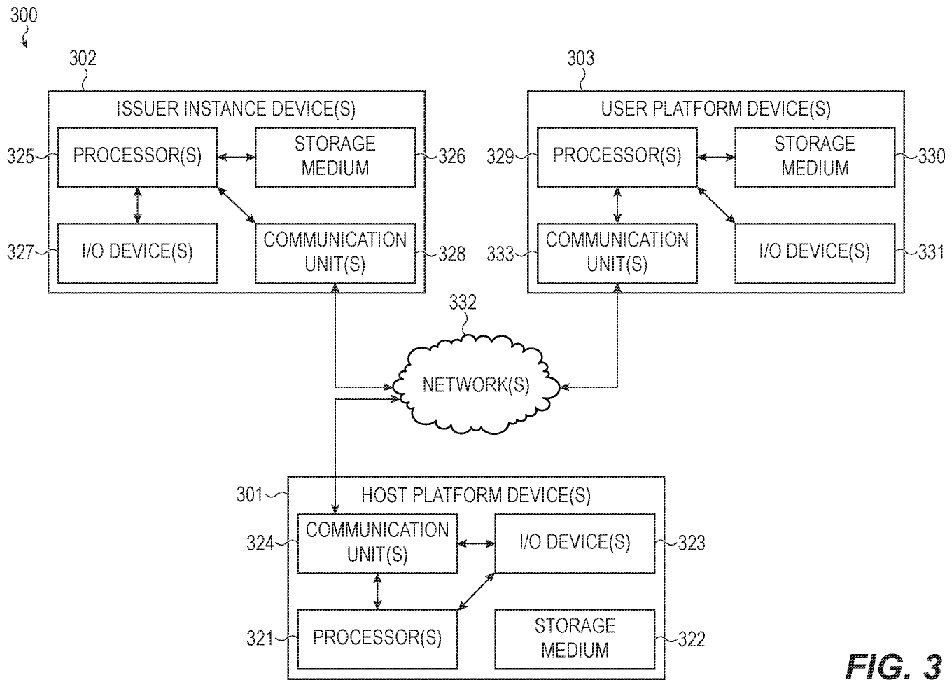

FIG. 3 depicts example relationships 300 among example components that may be used to implement the system 100 of FIG. 1A.

The host platform 101 of FIG. 1 may be implemented using one or more host platform devices 301. The host platform device 301 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The host platform device 301 may include one or more processors 321 and/or other processing units and/or controllers, one or more non-transitory storage media 322 (which may take the form of, but is not limited to, a magnetic storage medium; optical storage medium; magneto-optical storage medium; read only memory; random access memory; erasable programmable memory; flash memory; and so on), one or more communication units 324 (such as one or more network adapters and/or other devices used by a device to communicate with one or more other devices), one or more input and/or output components 323 (such as one or more displays, speakers, touch screens, computer mice, track pads, keyboards, printers, and so on) and/or one or more other components. The processor 321 may execute instructions stored in the non-transitory storage medium 322 to perform various functions. Such functions may include any of the functions discussed herein with respect to the host platform 101 of FIG. 1A; communicating with one or more issuer instance devices 302, user platform devices 303, and/or one or more other devices via one or more wired and/or wireless networks 332; and so on. Alternatively and/or additionally, the host platform device 301 may involve one or more memory allocations configured to store at least one executable asset and one or more processor allocations configured to access the one or more memory allocations and execute the at least one executable asset to instantiate one or more processes and/or services, such as one or more host platform services, and so on.

Similarly, the issuer instance 102 of FIG. 1A may be implemented using one or more issuer instance devices 302. The issuer instance device 302 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The issuer instance device 302 may include one or more processors 325 and/or other processing units and/or controllers, one or more non-transitory storage media 326 (which may take the form of, but is not limited to, a magnetic storage medium; optical storage medium; magneto-optical storage medium; read only memory; random access memory; erasable programmable memory; flash memory; and so on), one or more communication units 328 (such as one or more network adapters and/or other devices used by a device to communicate with one or more other devices), one or more input and/or output components 327 (such as one or more displays, speakers, touch screens, computer mice, track pads, keyboards, printers, and so on) and/or one or more other components. The processor 325 may execute instructions stored in the non-transitory storage medium 326 to perform various functions. Such functions may include any of the functions discussed herein with respect to the issuer instance 102 of FIG. 1A; communicating with one or more host platform devices 301, user platform devices 303, and/or one or more other devices via one or more wired and/or wireless networks 332; and so on. Alternatively and/or additionally, the issuer instance device 302 may involve one or more memory allocations configured to store at least one executable asset and one or more processor allocations configured to access the one or more memory allocations and execute the at least one executable asset to instantiate one or more processes and/or services, such as one or more issuer instance services, and so on.

Likewise, the user platform 103 of FIG. 1A may be implemented using one or more user platform devices 303. The user platform device 303 may be any kind of electronic device. Examples of such devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The user platform device 303 may include one or more processors 329 and/or other processing units and/or controllers, one or more non-transitory storage media 330 (which may take the form of, but is not limited to, a magnetic storage medium; optical storage medium; magneto-optical storage medium; read only memory; random access memory; erasable programmable memory; flash memory; and so on), one or more communication units 333 (such as one or more network adapters and/or other devices used by a device to communicate with one or more other devices), one or more input and/or output components 331 (such as one or more displays, speakers, touch screens, computer mice, track pads, keyboards, printers, and so on) and/or one or more other components. The processor 329 may execute instructions stored in the non-transitory storage medium 330 to perform various functions. Such functions may include any of the functions discussed herein with respect to the user platform 103 of FIG. 1A; communicating with one or more issuer instance devices 302, host platform devices 301, and/or one or more other devices via one or more wired and/or wireless networks 332; and so on. Alternatively and/or additionally, the user platform device 303 may involve one or more memory allocations configured to store at least one executable asset and one or more processor allocations configured to access the one or more memory allocations and execute the at least one executable asset to instantiate one or more processes and/or services, such as one or more user platform services, and so on.

Additionally, FIG. 1A may involve one or more other devices not shown. Such other devices may be any kind of electronic device. Examples of such other devices include, but are not limited to, one or more desktop computing devices, laptop computing devices, server computing devices, mobile computing devices, tablet computing devices, set top boxes, digital video recorders, televisions, displays, wearable devices, smart phones, digital media players, and so on. The other devices may include one or more processors and/or other processing units and/or controllers, one or more non-transitory storage media (which may take the form of, but is not limited to, a magnetic storage medium; optical storage medium; magneto-optical storage medium; read only memory; random access memory; erasable programmable memory; flash memory; and so on), one or more communication units (such as one or more network adapters and/or other devices used by a device to communicate with one or more other devices), one or more input and/or output components (such as one or more displays, speakers, touch screens, computer mice, track pads, keyboards, printers, and so on) and/or one or more other components. The processor may execute instructions stored in the non-transitory storage medium to perform various functions. Such functions may include any of the functions discussed herein; communicating with one or more issuer instance devices 302, user platform devices 303, host platform devices 301, and/or one or more other devices via one or more wired and/or wireless networks 332; and so on. Alternatively and/or additionally, the other devices may involve one or more memory allocations configured to store at least one executable asset and one or more processor allocations configured to access the one or more memory allocations and execute the at least one executable asset to instantiate one or more processes and/or services, such as one or more other device services, and so on.

As used herein, the term “computing resource” (along with other similar terms and phrases, including, but not limited to, “computing device” and “computing network”) refers to any physical and/or virtual electronic device or machine component, or set or group of interconnected and/or communicably coupled physical and/or virtual electronic devices or machine components, suitable to execute or cause to be executed one or more arithmetic or logical operations on digital data.

Example computing resources contemplated herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices and systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

Example information can include, but may not be limited to: personal identification information (e.g., names, social security numbers, telephone numbers, email addresses, physical addresses, driver's license information, passport numbers, and so on); identity documents (e.g., driver's licenses, passports, government identification cards or credentials, and so on); protected health information (e.g., medical records, dental records, and so on); financial, banking, credit, or debt information; third-party service account information (e.g., usernames, passwords, social media handles, and so on); encrypted or unencrypted files; database files; network connection logs; shell history; filesystem files; libraries, frameworks, and binaries; registry entries; settings files; executing processes; hardware vendors, versions, and/or information associated with the compromised computing resource; installed applications or services; password hashes; idle time, uptime, and/or last login time; document files; product renderings; presentation files; image files; customer information; configuration files; passwords; and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed leveraging any number of suitable libraries, frameworks, first- or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference to an implementation in which discrete functions of the system are implemented as discrete microservices. It is appreciated that this is merely one possible implementation.

As described herein, the term “processor” refers to any software and/or hardware-implemented data processing device or circuit physically and/or structurally configured to instantiate one or more classes or objects that are purpose-configured to perform specific transformations of data including operations represented as code and/or instructions included in a program that can be stored within, and accessed from, a memory. This term is meant to encompass a single processor or processing unit, multiple processors, multiple processing units, analog or digital circuits, or other suitably configured computing element or combination of elements.

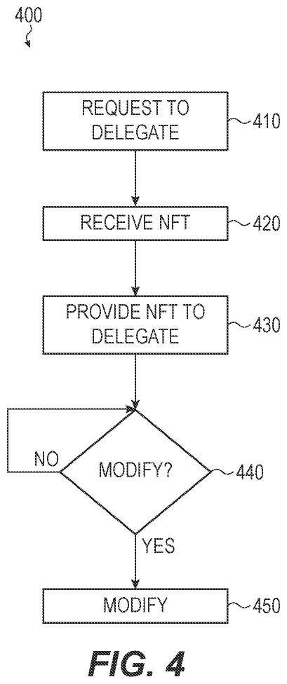

FIG. 4 depicts a flow chart illustrating a second example method 400 for operating a NFT authentication system. This method 400 may be performed by the system 100 of FIG. 1A.

At operation 410, an electronic device (such as one or more computing devices associated with the host platform 101 of FIG. 1A, the issuer instance 102 of FIG. 1A, the user platform 103 of FIG. 1A, and/or another device or system) may submit a request to delegate authority. The electronic device may submit the request to delegate the authority to a host platform, such as the host platform 101 of FIG. 1A. The electronic device may submit the request to delegate the authority on behalf of a delegator who instructs the electronic device to delegate the authority to a delegate.

At operation 420, the electronic device may receive a NFT associated with the delegated authority. The NFT may have been created in response to the request, associated with a smart contract (which may also have been created in response to the request), stored on a blockchain (with or without the smart contract), and so on. The electronic device receiving the NFT may include the electronic device actually receiving the NFT and/or may include the electronic device receiving an indication that the NFT was created and associated with a token wallet that may be accessible by and/or via the electronic device, such as a token wallet associated with the delegator.

The flow may proceed to operation 430 where the electronic device may provide the NFT to the delegate. The electronic device may provide the NFT to the delegate by transferring the NFT to a token wallet associated with the delegate. The electronic device may transfer the NFT to the token wallet associated with the delegate from a token wallet associated with the delegator. The electronic device may transfer the NFT to the token wallet associated with the delegate using the associated smart contract, which may control how the NFT may be transferred.

At operation 440, the electronic device may determine whether or not to modify the delegated authority. The electronic device may determine to modify the authority in response to receiving a request from the delegator to modify the authority, presuming the smart contract allows the delegator to modify the authority. Modification of the authority may include revoking the NFT, issuing a replacement NFT, modifying the smart contract, cancelling the smart contract, marking the NFT invalid, changing the delegated authority, and so on. If so, the flow may proceed to operation 450 where the electronic device may modify the delegated authority. Otherwise, the flow may return to operation 440 where the electronic device may again determine whether or not to modify the delegated authority.

By way of example, a hotel front desk employee may use a front desk computing device to assign a hotel room to a customer for 24 hours. As part of this, the hotel front desk employee may use the front desk computing device to request delegation of authority to use the hotel room to the customer. The request may provide an email address of the customer. The front desk computing device requesting the delegation of authority may result in creation of an NFT and an associated smart contract that delegates to the customer the authority to use the room for 24 hours, after which the NFT may expire. This NFT may be associated with a token wallet that may be automatically created and associated with the email address of the customer. When the NFT is associated with the smart wallet, an email notifying the customer of the association may be sent to the email address. The email may include a link for the customer to click from a mobile computing device, which may open an app on the mobile computing device that the customer may use to unlock a door to the hotel room via Bluetooth™ and/or another wireless communication technology.

In various examples, this example method 400 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 400 is illustrated and described as including particular operations performed in a particular order, it is understood that this is an example. In various implementations, various orders of the same, similar, and/or different operations may be performed without departing from the scope of the present disclosure.

For example, the method 400 illustrates and describes the electronic device receiving the NFT. However, it is understood that this is an example. In various examples, the electronic device may neither receive the NFT and/or an indication that the NFT was created. Instead, in some implementations, the NFT may be associated with a token wallet accessible to the electronic device and the electronic device may then be used to provide the NFT to the delegate. Additionally, in a number of examples, the NFT may be provided to the delegate by the device or system that created the NFT without the electronic device being involved after requesting delegation of the authority. Various configurations are possible and contemplated without departing from the scope of the present disclosure.

Further, the method 400 illustrates and describes the electronic device determining whether or not to modify the delegated authority, delegating the authority, and so on. However, it is understood that this is an example. In various examples, one or more other devices may perform such functions and the electronic device may be uninvolved. Various configurations are possible and contemplated without departing from the scope of the present disclosure.

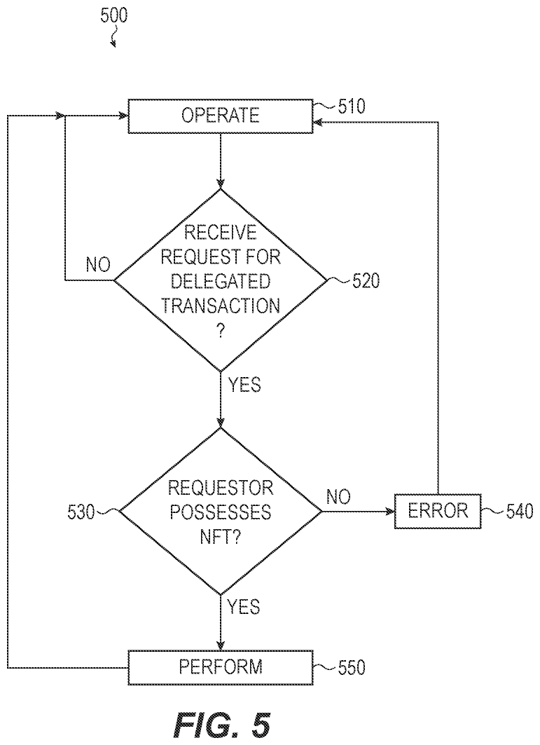

FIG. 5 depicts a flow chart illustrating a third example method 500 for operating a NFT authentication system. This method 500 may be performed by the system 100 of FIG. 1A.

At operation 510, an electronic device (such as one or more computing devices associated with the host platform 101 of FIG. 1A, the issuer instance 102 of FIG. 1A, the user platform 103 of FIG. 1A, and/or another device or system) may operate. At operation 520, the electronic device may receive a request for a delegated transaction. A delegated transaction may be a transaction that requires delegated authority associated with an NFT and/or smart contract in order to be performed. The delegated authority may be delegated in the smart contract by a delegator to a delegate associated with the NFT. The electronic device may receive a request to perform the delegated transaction from the delegate. If so, the flow may proceed to operation 530. Otherwise, the flow may return to operation 510 where the electronic device may continue to operate.

At operation 530, the electronic device receives a request for a delegated transaction, and the electronic device may determine whether or not a requestor associated with the request possesses an NFT associated with delegated authority to perform the delegated transaction. The electronic device may determine that the requestor possesses the NFT when the NFT is associated with a token wallet that is associated with the requestor, whether that token wallet is stored locally on a device from which the requestor submitted the request, the token wallet is a cloud-based token wallet to which the requestor has access, and so on. If so, the electronic device may perform the transaction at operation 550 before the flow returns to operation 510 and the electronic device continues to operate. Otherwise, the electronic device may indicate that an error has occurred at operation 540 before the flow returns to operation 510 and the electronic device continues to operate.

For example, the electronic device may be a server computing device that administers a rewards program for a merchant. The rewards program may track customer purchases at a merchant and may issue NFTs enabling customers to claim $20 in merchant merchandise for every ten purchases that the customers make from the merchant. The server computing device may receive a request from a customer to claim $20 in merchant merchandise. In response, the server computing device may determine whether or not an NFT enabling the customer to claim the $20 in merchant merchandise is associated with a token wallet that is associated with the customer. If so, the server computing device may allow the customer to claim the $20 in merchant merchandise. Otherwise, the server computing device may indicate that the customer does not have authority to claim the $20 in merchant merchandise.

Further in this example, the smart contract controlling the NFT may allow the customer to transfer the NFT enabling the customer to claim $20 in merchant merchandise to another customer for a $1 fee. In such implementations, the customer may request such a transfer and the server computing device may respond by deducting $1 from a payment method on file for the customer and transferring the NFT. Alternatively, the server computing device may revoke the NFT, replace the NFT with a new NFT entitling the customer to claim $19 in merchant merchandise, and transfer the new NFT to the other customer.

In some such examples, the other customer may not be a customer at the time of the transfer of the new NFT. Instead, the customer may provide an email address or other communication address of the other customer and a token wallet associated with the email address may be created for the other customer. The new NFT may then be transferred to the token wallet and a notification may be sent to the other customer at the email address letting the other customer know that they can claim $19 in merchant merchandise. This improves user interfaces and the operation of computing devices associated with NFT transfer as the other customer does not have to know how to set up a token wallet and/or does not have to interact with one or more computing devices to do so. Various configurations are possible and contemplated without departing from the scope of the present disclosure.

In various examples, this example method 500 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 500 is illustrated and described as including particular operations performed in a particular order, it is understood that this is an example. In various implementations, various orders of the same, similar, and/or different operations may be performed without departing from the scope of the present disclosure.

For example, the method 500 is illustrated and described as the electronic device performing the transaction. However, it is understood that this is an example. In various implementations, the electronic device may instead instruct another electronic device to perform the transaction. Various configurations are possible and contemplated without departing from the scope of the present disclosure.

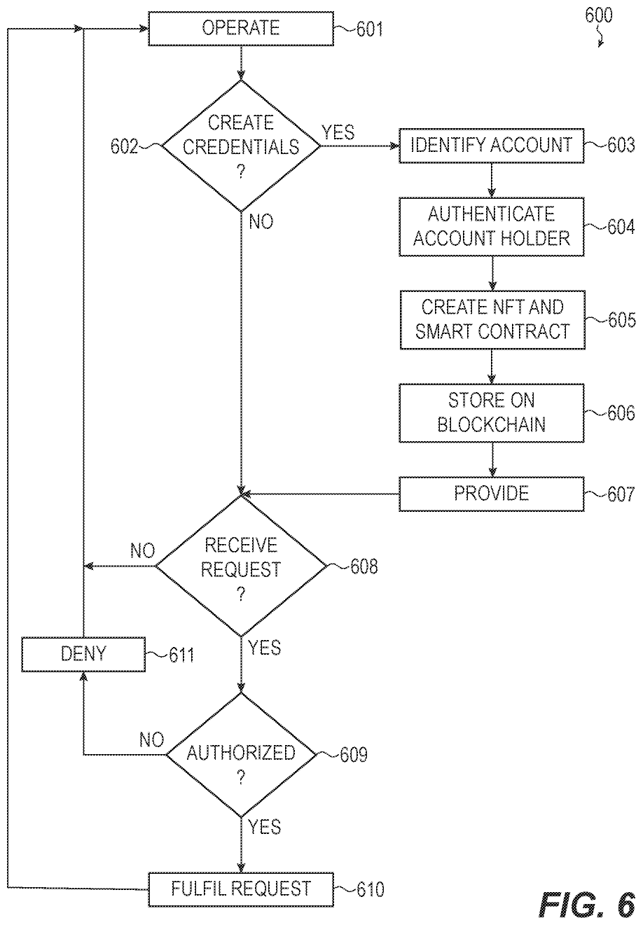

FIG. 6 depicts a flow chart illustrating a fourth example method 600 for operating a NFT authentication system. This method 600 may be performed by the system 100 of FIG. 1A.

At operation 601, an electronic device (such as one or more computing devices associated with the host platform 101 of FIG. 1A, the issuer instance 102 of FIG. 1A, the user platform 103 of FIG. 1A, and/or another device or system) may operate. At operation 602, the electronic device may determine whether or not to create one or more credentials. Such credentials may be used to prove authentication to perform actions related to an account (such as a frequent flyer account, a bank account, a content delivery system account, and so on). If so, the flow may proceed to operation 603. Otherwise, the flow may proceed to operation 608.

At operation 603, after the electronic device determines to create one or more credentials, the electronic device may identify an account for which to create the one or more credentials. The electronic device may identify the account by determining one or more account numbers to associate with the one or more credentials.

The flow may then proceed to operation 604 where the electronic device may authenticate the account holder. The authentication may involve multi-factor authentication. For example, the electronic device may have a communication address that is associated with the account holder, such as an email, and may transmit a one-time password to the communication address and then prompt for the one time password that was transmitted to the communication address.

Next, the flow may proceed to operation 605 where the electronic device may create an NFT with an associated smart contract. The electronic device may use information associated with the account to create the NFT. The flow may then proceed to operation 606 where the electronic device may store the NFT and/or the smart contract on one or more blockchains. Next, the flow may proceed to operation 607 where the electronic device may provide access to the NFT to the account holder before the flow proceeds to operation 608.

At operation 608, the electronic device may determine whether or not one or more requests that require authorization are received. If not, the flow may return to operation 601 and the electronic device may continue to operate. Otherwise, the flow may proceed to operation 609.

At operation 609, after the electronic device determines that one or more requests that require authorization are received, the electronic device may determine whether or not the request is authorized. This may be performed by determining whether or not an NFT associated with a smart contract authorizing performance of the request is associated with a token wallet associated with the requestor. If so, the flow may proceed to operation 610 where the electronic device may fulfil the request before the flow returns to operation 601 and the electronic device continues to operate. Otherwise, the flow may proceed to operation 611 where the electronic device may deny the request before the flow returns to operation 601 and the electronic device continues to operate.

By way of example, an airline web site may use NFTs as credentials for using frequent flier awards. As such, when a customer earns a frequent flier award, the airline web site may identify the customer's account, authenticate the customer by sending a one-time password to the customer's email address on file and then prompting for the password, creating a token wallet associated with the customer's email address (of which the customer may not be aware and to which the customer may not have access), and then create the NFT for the frequent flier award and associate it with the token wallet. Subsequently, when the user looks up his frequent flier award status, the electronic device may access the token wallet and display award information for any NFTs in the token wallet.

In various examples, this example method 600 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 600 is illustrated and described as including particular operations performed in a particular order, it is understood that this is an example. In various implementations, various orders of the same, similar, and/or different operations may be performed without departing from the scope of the present disclosure.

For example, the method 600 is illustrated and described as identifying an account after determining to create one or more credentials. However, it is understood that this is an example. In various implementations, the electronic device may determine to create one or more credentials as part of creating a new account. As such, the operation of identifying the account may be omitted. Various configurations are possible and contemplated without departing from the scope of the present disclosure.

Further, the method 600 is illustrated and described as both creating the credentials and determining whether or not requests are authorized. However, it is understood that this is an example. In some implementations, these operations may be performed by different devices. Various configurations are possible and contemplated without departing from the scope of the present disclosure.

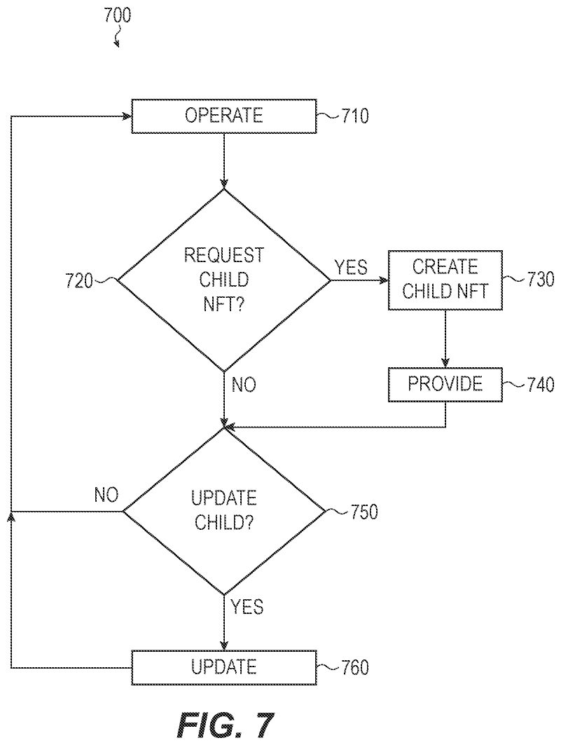

FIG. 7 depicts a flow chart illustrating a fifth example method 700 for operating a NFT authentication system. This method 700 may be performed by the system 100 of FIG. 1A.

At operation 710, an electronic device (such as one or more computing devices associated with the host platform 101 of FIG. 1A, the issuer instance 102 of FIG. 1A, the user platform 103 of FIG. 1A, and/or another device or system) may operate.

The flow may then proceed to operation 720 where the electronic device determines whether or not one or more requests for one or more child NFTs are received. The one or more child NFTs may be requested by the holder of an NFT (which may be a parent NFT once the one or more child NFTs are created) associated with a smart contract that authorizes creation of the one or more child NFTs. For example, a content delivery system may use NFTs to prove authorization to access content delivery system content. A single NFT may be provided to the account holder for the account holder's use, but the associated smart contract may allow the account holder to request the one or more child NFTs to provide to others for use. The associated smart contract may specify the kind of access that is associated with the one or more child NFTs, how many child NFTs may be created, any charge for creating the one or more child NFTs, how long before created child NFTs expire, and so on. If so, the flow may proceed to operation 730. Otherwise, the flow may proceed to operation 750.

At operation 730, after the electronic device determines that one or more requests for one or more child NFTs are received, the electronic device may create the one or more child NFTs. The flow may then proceed to operation 740 where the electronic device may provide the created one or more child NFTs before the flow proceeds to operation 750.

At operation 750, the electronic device may determine whether or not to update one or more created child NFTs. The electronic device may determine to update the one or more child NFTs if the one or more child NFTs have been stolen, have been misused, were created from a parent NFT that is no longer valid, have expired, and so on. Updating may include revoking, replacing, and/or otherwise modifying the authorization associated with the one or more child NFTs. If so, the flow may proceed to operation 760 where the electronic device may update the one more child NFTs before the flow returns to operation 710 and the electronic device continues to operate. Otherwise, the flow may proceed directly to operation 710 and the electronic device continues to operate.

By way of illustration, a cellular service may use NFTs to authorize use of cellular devices on a cellular network instead of SIM (subscriber identity module) cards. Each subscriber may be allowed to pay a fee to create up to five child NFTs that the subscriber may provide to others to use a more limited version of the cellular network than the one to which the subscriber has access. However, the subscriber may cancel his account. In such a case, the cellular service may revoke both the parent NFT held by the subscriber as well as the child NFTs associated with the parent NFT. Various configurations are possible and contemplated without departing from the scope of the present disclosure.

In various examples, this example method 700 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 700 is illustrated and described as including particular operations performed in a particular order, it is understood that this is an example. In various implementations, various orders of the same, similar, and/or different operations may be performed without departing from the scope of the present disclosure.

For example, the method 700 is illustrated and described as determining whether or not to update one or more child NFTs after determining whether or not one or more requests to create one or more child NFTs are received. However, it is understood that this is an example. In various implementations, such operations may be performed in different orders, omitted, and so on. Various configurations are possible and contemplated without departing from the scope of the present disclosure.

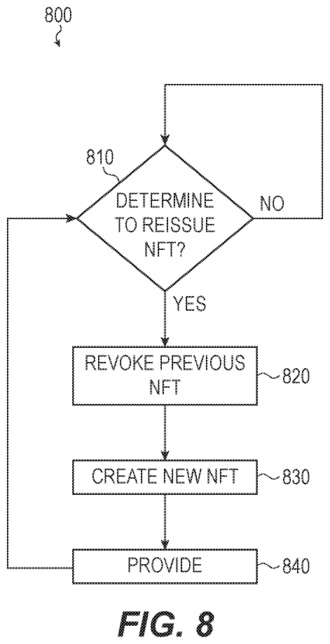

FIG. 8 depicts a flow chart illustrating a sixth example method 800 for operating an NFT authentication system. This method 800 may be performed by the system 100 of FIG. 1A.

At operation 810, an electronic device (such as one or more computing devices associated with the host platform 101 of FIG. 1A, the issuer instance 102 of FIG. 1A, the user platform 103 of FIG. 1A, and/or another device or system) may determine whether or not to reissue an existing NFT. For example, an electronic device may determine to reissue an NFT used to prove authorization to perform one or more actions because the NFT has been lost. If not, the flow may return to operation 810 where the electronic device may again determine whether or not to reissue an existing NFT. Otherwise, the flow may proceed to operation 820.

At operation 820, the electronic device may revoke the previous existing NFT. The flow may then proceed to operation 830 where the electronic device may create the new NFT. Next, the flow may proceed to operation 840 where the electronic device may provide the new NFT.

The flow may return to operation 810 where the electronic device may continue to operate.

For example, a grocery store may use NFTs to prove authorization for a frequent buyer club program. However, a customer may lose access to a token wallet where the authorization NFT is stored. The customer may prove his identity using various techniques such as a login and password and inform the grocery store that the token wallet is no longer accessible. In response, the grocery store may revoke the previous existing NFT, create a new NFT, and provide the new NFT to the customer. Various configurations are possible and contemplated without departing from the scope of the present disclosure.

In various examples, this example method 800 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 800 is illustrated and described as including particular operations performed in a particular order, it is understood that this is an example. In various implementations, various orders of the same, similar, and/or different operations may be performed without departing from the scope of the present disclosure.

For example, the method 800 is illustrated and described as revoking a previous existing NFT. However, it is understood that this is an example. In various implementations, the previous existing NFT may already be unusable (such as where the previous existing NFT is already expired) and the operation of revoking the previous existing NFT may be omitted. Various configurations are possible and contemplated without departing from the scope of the present disclosure.

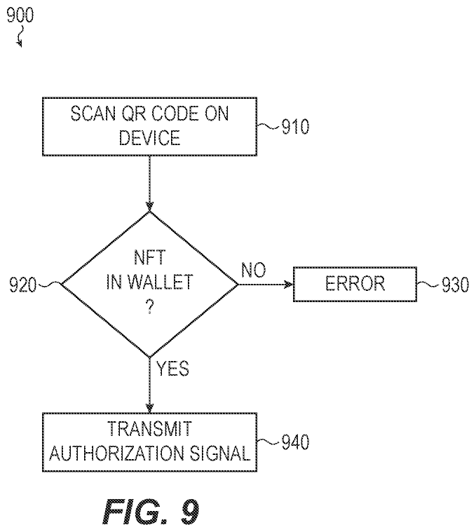

FIG. 9 depicts a flow chart illustrating a seventh example method 900 for operating a NFT authentication system. This method 900 may be performed by the system 100 of FIG. 1A.

At operation 910, an electronic device (such as one or more computing devices associated with the host platform 101 of FIG. 1A, the issuer instance 102 of FIG. 1A, the user platform 103 of FIG. 1A, and/or another device or system) may scan a QR code displayed on a device. For example, the QR code may be displayed on a television by a streaming service in order to enable configuration of the streaming service to allow the television to display content from the streaming service on the television. The configuration may associate the television with a streaming service account that is authorized to access the content from the streaming service. Scanning the QR code may cause the electronic device to decode the QR code and execute one or more instructions that begin configuring the streaming service to allow the television to display the content.

At operation 920, the electronic device may determine whether one or more NFTs that authorize use of the television with the streaming service are associated with a token wallet associated with the electronic device. If not, the flow may proceed to operation 930 where the electronic device may determine that an error occurs. Otherwise, the flow may proceed to operation 940 where the electronic device may transmit an authorization signal to the streaming service to cause the streaming service to configure itself to allow the television to display the content.

In various examples, this example method 900 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 900 is illustrated and described as including particular operations performed in a particular order, it is understood that this is an example. In various implementations, various orders of the same, similar, and/or different operations may be performed without departing from the scope of the present disclosure.

For example, the method 900 is illustrated and described as transmitting an authorization signal to the streaming service to cause the streaming service to configure itself to allow the television to display the content. However, it is understood that this is an example. In various implementations, the electronic device may notify the streaming service that the configuration is authorized without transmitting an authorization signal. In still other implementations, the streaming service may itself verify authorization. Various configurations are possible and contemplated without departing from the scope of the present disclosure.

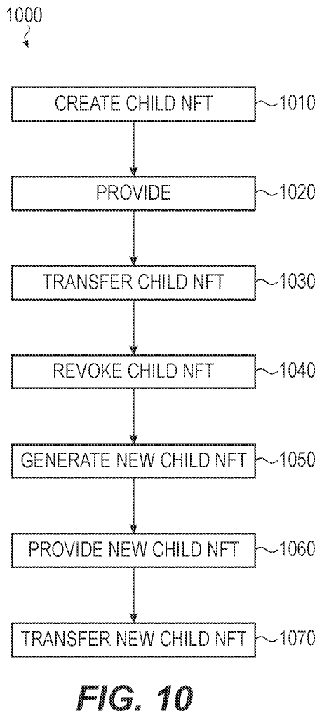

FIG. 10 depicts a flow chart illustrating an eighth example method 1000 for operating a NFT authentication system. This method 1000 may be performed by the system 100 of FIG. 1A.

At operation 1010, an electronic device (such as one or more computing devices associated with the host platform 101 of FIG. 1A, the issuer instance 102 of FIG. 1A, the user platform 103 of FIG. 1A, and/or another device or system) may create a child NFT. The flow may then proceed to operation 1020 where the electronic device may provide the child NFT. Next, the flow may proceed to operation 1030 where the electronic device may transfer the child NFT. The flow may then proceed to operation 1040 where the electronic device may revoke the NFT. Next, the flow may proceed to operation 1050 where the electronic device may generate a new child NFT. The flow may then proceed to operation 1060 where the electronic device may provide the new child NFT. Finally, the flow may proceed to operation 1070 where the electronic device may transfer the new child NFT.

By way of illustration, a WiFi network may use NFTs to authorize use of the WiFi network. The administrator of the WiFi network may be authorized to administer the WiFi network using a parent NFT. Users of the WiFi network may be authorized using one or more child NFTs created using the parent NFT. The WiFi network may only support a particular number of users at a particular time. As such, the WiFi administrator may request child NFTs, transfer the child NFTs to the users that the administrator has granted access, remove the transferred NFTs when access is to be ended, and request and then transfer new child NFTs to grant access to new users. Various configurations are possible and contemplated without departing from the scope of the present disclosure.

In various examples, this example method 1000 may be implemented as a group of interrelated software modules or components that perform various functions discussed herein. These software modules or components may be executed within a cloud network and/or by one or more computing devices, such as one or more computing devices associated with the host platform 101 of FIG. 1A, the issuer instance 102 of FIG. 1A, the user platform 103 of FIG. 1A, and/or another device or system.

Although the example method 1000 is illustrated and described as including particular operations performed in a particular order, it is understood that this is an example. In various implementations, various orders of the same, similar, and/or different operations may be performed without departing from the scope of the present disclosure.

For example, the method 1000 is illustrated and described in the context of a child NFT. However, it is understood that this is an example. In various implementations, the method 1000 may be performed in the context of a parent NFT and/or other NFT rather than a child NFT and/or in addition to being performed in the context of a child NFT. Various configurations are possible and contemplated without departing from the scope of the present disclosure.

In various implementations, a system may include a non-transitory storage medium storing instructions and a processor. The processor may execute the instructions to receive a request to delegate authority to a delegate on behalf of a delegator, generate an NFT and an associated smart contract, store the NFT and the associated smart contract on a blockchain, and provide the NFT wherein the NFT is usable by the delegate to make use of the authority.

In some examples, the processor may be operable to revoke the NFT in response to a request from the delegator. In a number of examples, the processor may be operable to generate a new NFT in response to a request from the delegator. In some such examples, the processor may provide the new NFT to at least one of the delegator or the delegate.

In various examples, the processor may be operable to generate a child NFT in response to a request from the delegate. In some examples, the processor may provide the NFT to at least one of the delegator or the delegate. In a number of examples, the NFT may expire after passage of an expiration date.

In some implementations, a system may include a non-transitory storage medium storing instructions and a processor. The processor may execute the instructions to provide a request to delegate authority to a delegate on behalf of a delegator to cause a host platform to generate an NFT and an associated smart contract and store the NFT and the associated smart contract on a blockchain and facilitate providing the NFT to the delegate wherein the NFT is usable by the delegate to make use of the authority.

In various examples, the delegator may be a streaming service, a gaming service, an airline site, a bank, or any other password protected site or application. In some implementations of such examples, the authority may be access to content from the streaming service or the gaming service. In a number of such examples, the access may be from a device, a website or the like, associated with a token wallet to which the NFT is assigned. A token may also be transferred with an expiration time, date and a set of rights delegated to a third party wallet attached to an app or website owned by the recipient which allows the recipient to log into to the target app or website and assume the identity of the first party without the first party having to share its user identifier or password.

In some examples, the NFT may be a child token generated on behalf of the delegator who has a parent token. In a number of examples, the processor may render the NFT unusable, generate a new NFT, and provide the new NFT. In some such examples, the processor may provide the new NFT to at least one of the delegator or the delegate.

In a number of implementations, a system may include a non-transitory storage medium storing instructions and a processor. The processor may execute the instructions to receive an NFT that was generated and stored on a blockchain with an associated smart contract by a host platform in response to a request to delegate authority to a delegate on behalf of a delegator and make use of the authority using the NFT in response to a request from the delegate.

In various examples, the processor may be operable to obtain a code from an electronic device, determine that the NFT is assigned to a token wallet associated with the processor, and submit an authorization request for the electronic device. In some such examples, the authorization request may request configuration of the electronic device with at least one of a streaming service or a gaming service.

In some examples, the processor may be operable to store the NFT in a token wallet associated with the processor. In various such examples, the token wallet may be integrated with at least one of a streaming service app, a gaming service app, an airline app, a bank app, or a financial institution app.

In a number of examples, the processor may be operable to transfer the NFT.

Although the above illustrates and describes a number of embodiments, it is understood that these are examples. In various implementations, various techniques of individual embodiments may be combined without departing from the scope of the present disclosure.

As described above and illustrated in the accompanying figures, the present disclosure relates to use of non-fungible tokens (NFTs) for authentication. An NFT and an associated smart contract may be generated and stored on a blockchain for authority that is to be delegated to a delegate on behalf of a delegator. The NFT may then be provided to the delegate, who may use the NFT to authenticate himself in order to act on the delegated authority. Subsequently, the NFT may be transferred, revoked, marked expired, and/or otherwise controlled by the delegator in order to control the authority delegated to the delegate.

In the present disclosure, the methods disclosed may be implemented as sets of instructions or software readable by a device. Further, it is understood that the specific order or hierarchy of steps in the methods disclosed are examples of sample approaches. In other embodiments, the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A system, comprising:
a non-transitory storage medium storing instructions; and
a processor that executes the instructions to:
receive a request to delegate authority to a delegate on behalf of a delegator;
generate a non-fungible token (NFT) and an associated smart contract;
store the NFT and the associated smart contract on a blockchain; and
provide the NFT wherein the NFT is usable by the delegate to make use of the authority.

2. The system of claim 1, wherein the processor is operable to revoke the NFT in response to a request from the delegator.

3. The system of claim 1, wherein the processor is operable to generate a new NFT in response to a request from the delegator.

4. The system of claim 3, wherein the processor provides the new NFT to at least one of the delegator or the delegate.

5. The system of claim 1, wherein the processor is operable to generate a child NFT in response to a request from the delegate.

6. The system of claim 1, wherein the processor provides the NFT to at least one of the delegator or the delegate.

7. The system of claim 1, wherein the NFT expires after passage of an expiration date.

8. A system, comprising:
a non-transitory storage medium storing instructions; and
a processor that executes the instructions to:
provide a request to delegate authority to a delegate on behalf of a delegator to cause a host platform to:
generate a non-fungible token (NFT) and an associated smart contract; and
store the NFT and the associated smart contract on a blockchain; and
facilitate providing the NFT to the delegate wherein the NFT is usable by the delegate to make use of the authority.

9. The system of claim 8, wherein the delegator comprises a streaming service, a gaming service, an airline site, a bank, or another password protected site or application.

10. The system of claim 9, wherein the authority comprises access to content from the a streaming service, the gaming service, the airline site, the bank, or the other password protected site or application.

11. The system of claim 10, wherein the access is from a device, a website or the like, associated with a token wallet to which the NFT is assigned.

12. The system of claim 8, wherein the NFT is a child token generated on behalf of the delegator who has a parent token.

13. The system of claim 8, wherein the processor:
renders the NFT unusable;
generates a new NFT; and
provides the new NFT.

14. The system of claim 13, wherein the processor provides the new NFT to at least one of the delegator or the delegate.

15. A system, comprising:
a non-transitory storage medium storing instructions; and
a processor that executes the instructions to:
receive a non-fungible token (NFT) that was generated and stored on a blockchain with an associated smart contract by a host platform in response to a request to delegate authority to a delegate on behalf of a delegator; and
make use of the authority using the NFT in response to a request from the delegate.

16. The system of claim 15, wherein the processor is operable to:
obtain a code from an electronic device;
determine that the NFT is assigned to a token wallet associated with the processor; and
submit an authorization request for the electronic device.

17. The system of claim 16, wherein the authorization request requests configuration of the electronic device with at least one of a streaming service or a gaming service.

18. The system of claim 15, wherein the processor is operable to store the NFT in a token wallet associated with the processor.

19. The system of claim 18, wherein the token wallet is integrated with at least one of a streaming service app, a gaming service app, an airline app, a bank app, or a financial institution app.

20. The system of claim 15, wherein the processor is operable to transfer the NFT.
